(19) United States
(12) Patent Application Publication
(10) Pub. No.: US 2007/0076145 A1
(43) Pub. Date: Apr. 5, 2007

(54) Display panel having a reflective layer therein

(75) Inventors: Yoshihiro Morimoto, Chu-Nan (TW); An Shih, Changhua (TW); Yi-Wen Tai, Hsinchu City (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/243,044

(22) Filed: Oct. 4, 2005

(51) Int. Cl. G02F 1/1335

(52) U.S. Cl. 349/114; 349/113

(57) ABSTRACT

A liquid crystal display panel having a plurality of pixels is provided. Each pixel may include a first substrate, a second substrate, a liquid crystal layer, a reflective layer and a cover layer. A surface of the second substrate includes a second transparent electrode. The liquid crystal layer is disposed between the first substrate and the second substrate. The reflective layer is disposed over at least a portion of the second transparent electrode. The cover layer is disposed over the reflective layer.

### BACKGROUND OF THE INVENTION

1. Field of the Invention

The present invention generally relates to a display device having a reflective layer therein. More particularly, the present invention relates to a structure of a liquid crystal display panel having a reflective layer therein, and a display device and electronic device using thereof.

2. Description of Related Art

In recent years, conventional cathode ray tube (CRT) display has been gradually replaced by liquid crystal display (LCD) since LCD has advantages of small size, thinner thickness, light weight, large or small area, low operation voltage, power saving, and radiation free. Therefore, LCD has been gradually adopted for the display device of a variety of electronic products, specially the portable electronic products such as notebook computer, mobile phone, personal digital assistant (PDA) and so on.

Conventionally, LCD is not self-illuminant, thus an external light source for liquid crystal panel is necessary. In general, conventional LCD may be classified into transmissive LCD, reflective LCD, and transflective LCD according to the type of light source of the LCD. The light source of transmissive LCD may be a back light module disposed behind the liquid crystal panel of the transmissive LCD. Therefore, a light is emitted from the back light module, and the polarization of the light may be changed by the liquid crystal molecules within the liquid crystal panel according to the image signal to generate an image. Thereafter, the image may be observed by the viewer.

Recently, the reflective LCD and transflective LCD are developed since the power consumption of the portable electronic products has to be minimized. In the transflective LCD, a back light module is disposed behind the liquid crystal panel, and the light in the surrounding environment of the LCD is allowed to pass through the liquid crystal panel. In addition, a layer including reflection region and transparent region is disposed on the liquid crystal panel. Therefore, the light from the surrounding environment is reflected by the reflection region, and the light from the back light module is allowed to pass through the transparent region. Thereafter, an image is generated after the polarization of the light from the light module or the light from the surrounding environment is changed by the liquid crystal molecules within the liquid crystal panel according to the data signal. Accordingly, the image may be observed by the viewer.

Therefore, the power consumption of the transflective LCD may be reduced drastically. Especially, the portable electronic product is often used outdoors. In general, when the outdoor is bright, the contrast ratio of the transmissive LCD is reduced since the brightness of background is high. However, the transflective LCD is not influenced since the light in the surrounding environment is used as the light source.

However, the conventional transflective LCD has the disadvantages that flickers of the displayed image are generated due to the difference of the work function between the first transparent electrode on a top substrate and the reflection electrode on a bottom substrate. It is necessary to improve the layer structure of the transflective LCD to improve flickers of the image.

### SUMMARY OF THE INVENTION

Therefore, the present invention relates to a liquid crystal display panel, wherein the flickers of the displayed image may be eliminated.

Furthermore, the present invention relates to a liquid crystal display device, wherein the flickers of the displayed image may be eliminated.

Moreover, the present invention relates to an electronic device that incorporates the novel LCD display panel, wherein the flickers of the displayed image may be eliminated.

In accordance with one aspect of the present invention, the reflective layer in a liquid crystal display is sandwiched between two transparent conductive layers (e.g., transparent electrodes of ITO, IZO). The liquid crystal display panel comprised of a plurality of pixels may comprise a first substrate, a second substrate, a liquid crystal layer, a reflective layer and a cover layer. A surface of the second substrate comprises a second transparent electrode. The liquid crystal layer is disposed between the first substrate and the second substrate. The reflective layer is disposed over at least a portion of the second transparent electrode. The cover layer is disposed over the reflective layer.

In one embodiment of the present invention, the reflective layer may further comprise at least a first reflective layer disposed between the cover layer and the second transparent electrode, and a second reflective layer disposed between the cover layer and the first reflective layer.

The liquid crystal display device of the present invention may comprise a liquid crystal display panel and a drive control circuit controlling imaging of the liquid crystal display panel. The display panel may be the liquid crystal display panel of the present invention described above, and thus will no more be described.

The electronic device of the present invention may comprise a liquid crystal display device and an input device for providing an input data to the liquid crystal display device for rendering an image. The display device may be the liquid crystal display device of the present invention described above, and thus will not be repeated again.

Accordingly, in the present invention, the reflective layer of the bottom substrate is disposed between the second transparent electrode and the cover layer. Since the first transparent electrode of the top substrate and the cover layer over the reflective layer of the bottom substrate may be composed of same material, the difference of the work function between the first transparent electrode of the top substrate and the cover layer of the bottom substrate may be minimized. Therefore, the flickers of the displayed image may be eliminated.

Moreover, since the reflective layer may include a first reflective layer disposed between the second transparent electrode and the second reflective layer, the junction resistance of the surface between the reflective layer and the second transparent electrode may be reduced. Therefore, the cross talk of the displayed image may also be eliminated.

Another aspect of the present invention is directed to a method of fabricating a display panel having the reflective layer sandwiched between two transparent layers in accordance with the present invention.

If the reflective layer over the second transparent electrode defines a transmissive region in each pixel, the liquid crystal display is a transflective type display. If the reflective layer completely covers the second transparent electrode with no transmissive regions in each pixel region, the liquid crystal display is a reflective type display.

One or part or all of these and other features and advantages of the present invention will become readily apparent to those skilled in this art from the following description wherein there is shown and described one embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic sectional view along line B-B′ in FIG. 2, illustrating a transflective LCD according to one embodiment of the present invention.

FIG. 2 is a schematic top view along line A-A′ of the transflective LCD shown in FIG. 1.

FIG. 3A to FIG. 3E are schematic sectional views illustrating the steps leasing to the structure of a reflective layer according to one embodiment of the present invention.

FIG. 4 is a schematic sectional view along line B-B′ in FIG. 5, illustrating a reflective LCD according to one embodiment of the present invention.

FIG. 5 is a schematic top view along line A-A′ of the reflective LCD shown in FIG. 4.

FIG. 6 is a block diagram illustrating a display device according to one embodiment of the present invention.

FIG. 7 is a block diagram illustrating an electronic device according to one embodiment of the present invention.

### DESCRIPTION OF EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

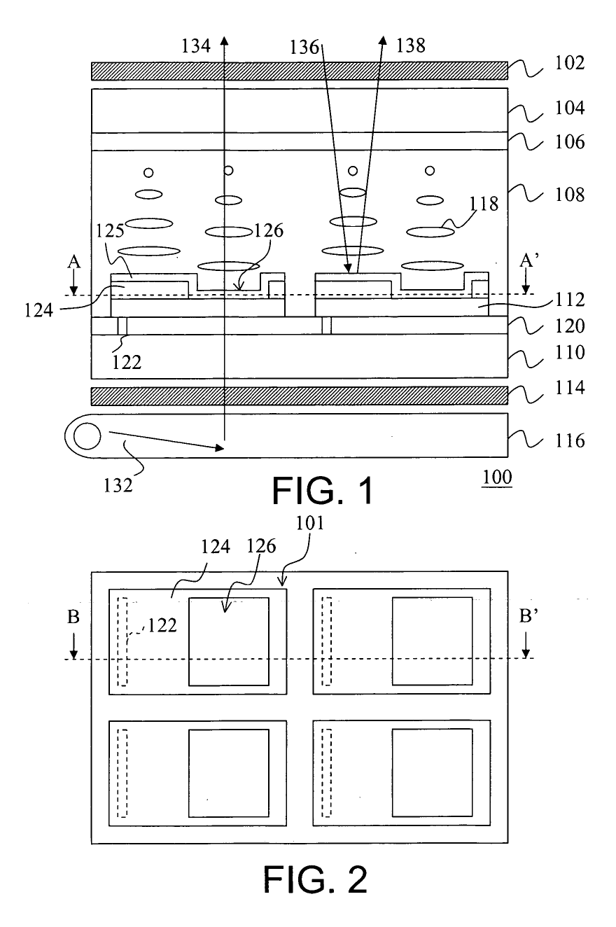

FIG. 1 is a schematic sectional view illustrating a transflective LCD according to one embodiment of the present invention. Referring to FIG. 1, the transflective LCD 100 comprises, for example but not limited to, a first polarizer 102, a first substrate 104, a first transparent electrode 106, a liquid crystal layer 108, a second substrate 110, a second transparent electrode 112, a second polarizer 114, a light source module 116, a reflective layer 124 and a cover layer 125. In this embodiment, the reflective layer 124 defines a transmissive region 126, and thus the display panel is a transflective LCD panel.

Referring to FIG. 1, the light 132 emitted from the light source module 116 may be totally reflected to form a light 134. A portion of the light 134 may pass through the transmissive region 126, and the polarization direction of the light 134 may be changed by the liquid crystal layer 108. In addition, a light 136 from the surrounding environment above the polarizer 102 may pass through the liquid crystal layer 108 and be reflected by the reflective layer 124 to form a light 138. Thereafter, if the polarized light 134 or 138 may pass through the first polarizer 102, the polarized light 134 or 138 may be observed by the viewer. Therefore, any one or both of the light 136 from the surrounding environment or the light 132 from the light source module 116 may be provided as the light source of the transflective LCD 100.

Referring to FIG. 1, the first substrate 104 and the second substrate 110 may comprise transparent substrate comprising, for example, glass substrate. The first transparent electrode 106 is formed over the first substrate 104 and the second transparent electrode 112 is formed over the second substrate 110. The material of the transparent electrode may comprise, indium tin oxide (ITO) or indium zinc oxide (IZO). The liquid crystal layer 108 comprising liquid crystal molecules 118 is filled between the first transparent electrode 106 and the second transparent electrode 112.

In one embodiment of the present invention, a semiconductor component layer 120 may be further disposed between the second transparent electrode 112 and the second substrate 110. The semiconductor component layer 120 may comprises, for example, a metal layer 122 connected to external display drivers (not shown) for driving the transflective LCD 100.

FIG. 2 is a schematic top view along line A-A′ of the transflective LCD 100 shown in FIG. 1. Referring to FIGS. 1 and 2, the reflective layer 124 is formed over the second transparent electrode 112 and defines a transmissive region 126, wherein each pixel 101 is generally defined within a boundary of the reflective layer 124. In other words, the reflective layer 124 in each pixel 101 has an opening, and the opening is regarded as the transmissive region 126. In particular, the cover layer 125 is formed over the reflective layer 124 and covered the transmissive region 126, and thus the reflective layer 124 is sandwiched between the cover layer 125 and the second transparent electrode 112. The transmissive region 126 is adopted for allowing the passing through of the light 134 from the light source module 116, and the reflective layer 124 is provided for reflecting the light 136 from the surrounding environment. In one embodiment of the present invention, the pixel 101 may comprise a monochromatic pixel or a sub-pixel having any one the three primary colors (red, green or blue). A metal layer 122 shown with dotted line in FIG. 2 represents a connection with external display drivers (not shown) for driving the pixel.

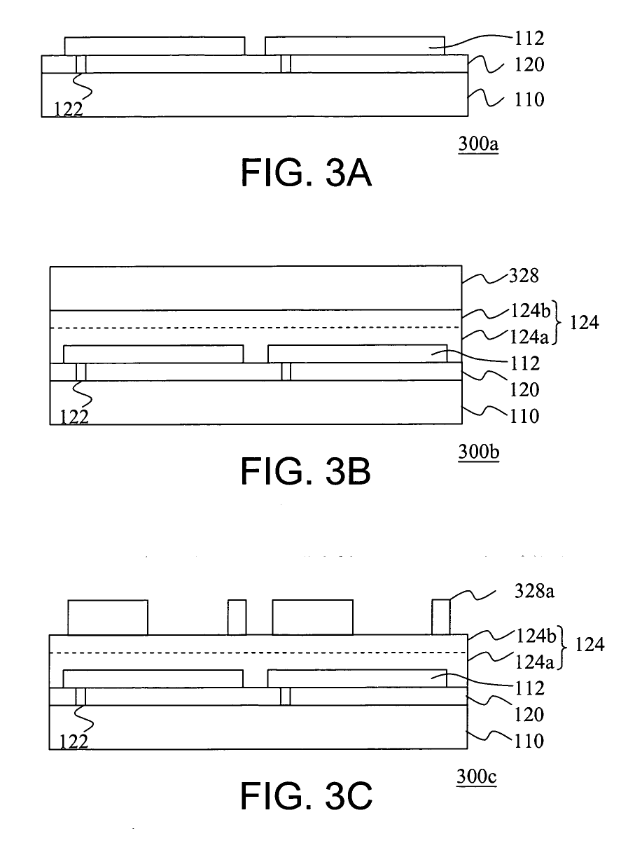

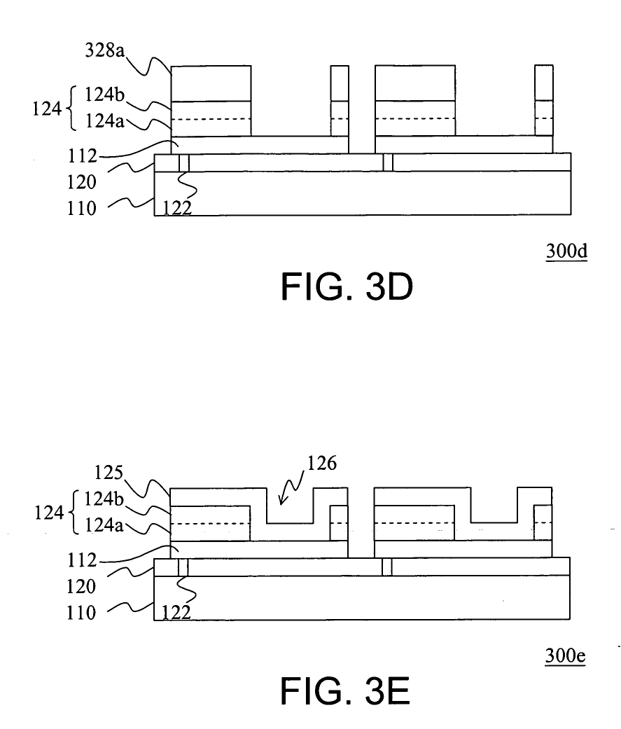

FIG. 3A to FIG. 3E are schematic cross-sectional views illustrating a manufacturing process of a reflective layer according to one embodiment of the present invention. Referring to FIG. 3A, a substrate structure 300a is formed by the following steps. First, a second substrate 110 comprising, for example, transparent substrate such as glass substrate is provided. Then, a second transparent electrode 112 is formed over the second substrate 110. The material of the second transparent electrode 112 may comprise, for example, indium tin oxide (ITO) or indium zinc oxide (IZO). In another embodiment of the present invention, a semiconductor component layer 120 comprising, for example, the metal layer 122 may be formed over the second substrate 110, and then the second transparent electrode 112 may be formed over the semiconductor component layer 120.

Next, referring to FIG. 3B, a reflective layer 124 and a photoresist layer 328 may be formed over the substrate structure 300a. Therefore, the substrate structure 300b is formed.

In one embodiment of the present invention, the reflective layer 124 may comprise a first reflective layer 124a and a second reflective layer 124b. The first reflective layer 124a is disposed over the second transparent electrode 112, and the material of the first reflective layer 124a may comprise molybdenum (Mo). The second reflective layer 124b is disposed over the first reflective layer 124a, and the material of the second reflective layer 124b may comprise aluminum neodymium (AlNd).

Thereafter, referring to FIG. 3C, the photoresist layer 328 is patterned to form a patterned photoresist layer 328a. Thus, the substrate structure 300c is obtained.

Next, referring to FIG. 3D, the reflective layer 124 is patterned to form the patterned reflective layer 124 including the patterned first reflective layer 124a and the patterned second reflective layer 124b. Therefore, the substrate structure 300d is obtained.

Thereafter, referring to FIG. 3E, the patterned photoresist layer 328a over the substrate structure 300e is removed, and then a cover layer 125 is formed over the reflective layer 124 covering the transmissive region 126. Thus, the substrate structure 300e is obtained. The material of the cover layer 125 may comprise indium tin oxide (ITO) or indium zinc oxide (IZO), and may be formed by, for example, physical vapor deposition (PVD) method. In one embodiment of the present invention, the material of the cover layer 125 may be same as that of the first transparent electrode 106 in FIG. 1 so that the cover layer 125 has the same work function to that of the first transparent electrode 106 in FIG. 1.

Referring to FIG. 3E, in one embodiment of the present invention, an anistropic conductive film (ACF) (not shown) may also be disposed over the cover layer 125. It is noted that the conductivity between the cover layer 125 and the anistropic conductive film is much better than that between the reflective layer 124 and the anistropic conductive film. Therefore, the driving capacity of the transflective LCD of the present invention may be enhanced.

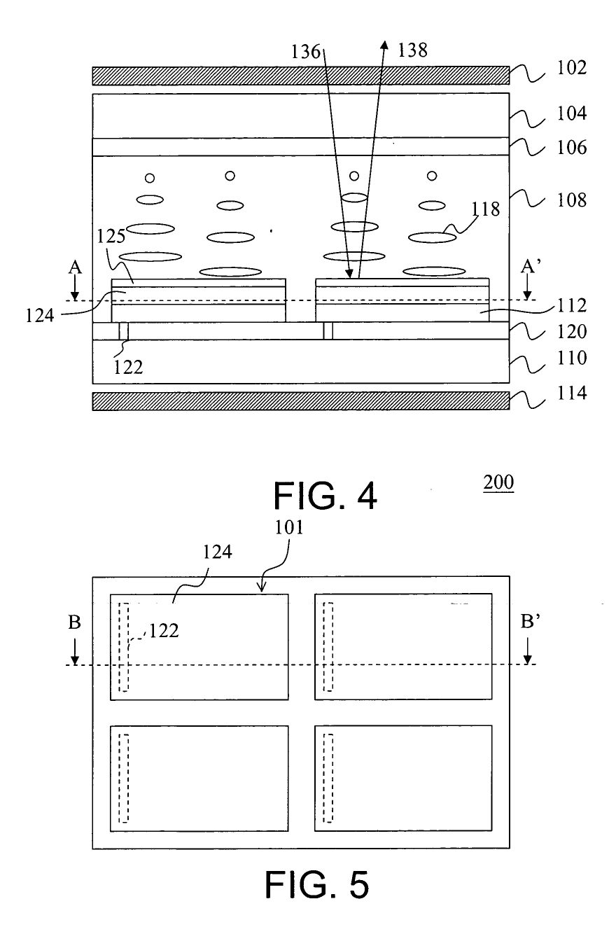

Switching a reflective layer between two transparent layers to eliminate the flickers of the displayed image may also be applied to a reflective type display. As shown in FIG. 4 and FIG. 5, the reflective LCD panel 200 is similar to that drawn in FIGS. 1 and 2. The difference between the two LCD panels is that the reflective layer 124 and the cover layer 125 of FIG. 4 and FIG. 5 completely cover the second transparent electrode 112 in each pixel 101 with no transmissive regions. Thus, the display panel 200 is a reflective LCD panel, and a light source module is not required.

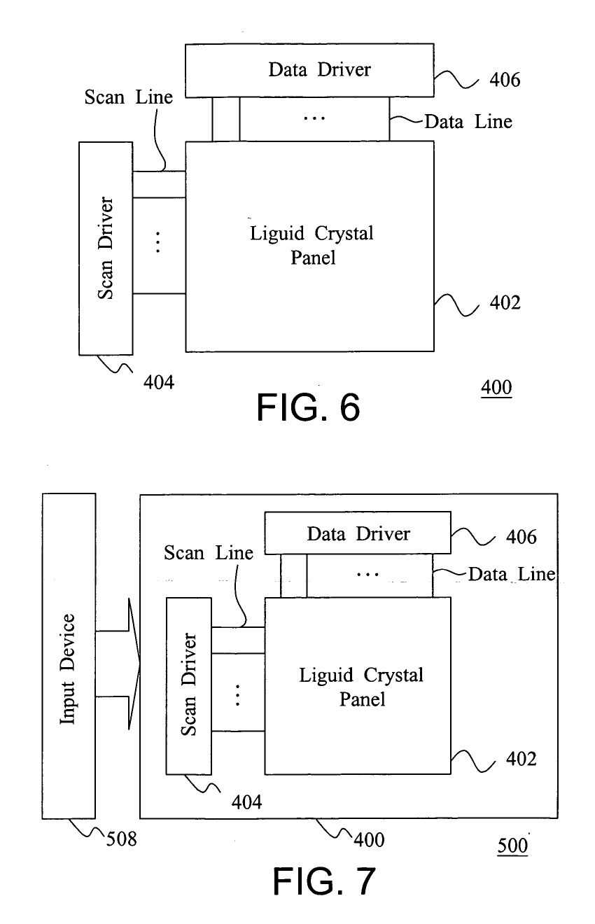

FIG. 6 is a block diagram illustrating a display device according to one embodiment of the present invention. Examples of the display device include flat panel display monitors. The display device 400 may comprise, for example, a liquid crystal display panel 402 and a drive control circuit, such as a scan driver 404 and a data driver 406, for controlling imaging of the liquid crystal display panel 402. The scan driver 404 connected to the display panel 402 via a plurality of scan lines, and the data driver 406 connected to the display panel 402 via a plurality of data lines. The display panel 402 may comprise the transflective LCD panel or the reflective LCD panel of the present invention described above and thus will not be repeated again.

FIG. 7 is a block diagram illustrating an electronic device according to one embodiment of the present invention. Referring to FIG. 5, an electronic device 500 comprises, for example, the display device 400 as shown in FIG. 4 and an input device 508 for providing an input data to the liquid crystal display device 400 for rendering an image. The input device 508 may be adopted for receiving the image data, the command from the user and so on.

Accordingly, in the present invention, the reflective layer is disposed between the second transparent electrode and the cover layer. Since the first transparent electrode and the cover layer may be composed of same material, the difference of the work function between the first transparent electrode and the cover layer may be minimized. Therefore, the flickers of the displayed image may be eliminated.

In addition, since the second transparent electrode is disposed between the reflective layer and the semiconductor component layer including the metal layer and the cover layer is formed covering the reflective layer and the transmissive region, the crack or break of the reflective layer at the junction between the reflective layer and the transmissive region may also be eliminated.

Moreover, since the reflective layer may include a first reflective layer disposed between the second transparent electrode and the second reflective layer, the junction resistance of the surface between the reflective layer and the second transparent electrode may be reduced. Therefore, the cross talk of the displayed image may also be eliminated.

The foregoing description of the embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A liquid crystal display panel comprising a plurality of pixels, each pixel comprising:
a first substrate wherein a surface of the second substrate comprises a first transparent electrode;
a second substrate, wherein a surface of the second substrate comprises a second transparent electrode;
a reflective layer, disposed over at least a portion of the second transparent electrode;
a cover layer, disposed over the reflective layer; and
a liquid crystal layer, disposed between the first substrate and the second substrate.

2. The liquid crystal display device of claim 1, wherein the reflective layer further comprises at least a first reflective layer disposed between the cover layer and the second transparent electrode, and a second reflective layer disposed between the cover layer and the first reflective layer.

3. The liquid crystal display device of claim 2, wherein a material of the first reflective layer comprises molybdenum.

4. The liquid crystal display device of claim 2, wherein a material of the second reflective layer comprises aluminum neodymium.

5. The liquid crystal display device of claim 1, wherein the cover layer has a material as same as that of the first transparent electrode.

6. The liquid crystal display device of claim 1, wherein a material of the second transparent electrode or the cover layer comprises an indium tin oxide (ITO) or an indium zinc oxide (IZO).

7. The liquid crystal display device of claim 1, wherein the reflective layer completely covers the second transparent electrode in each pixel.

8. The liquid crystal display device of claim 1, wherein the reflective layer over the second transparent electrode defines a transmissive region in each pixel, and the cover layer covers the reflective layer and the transmissive region.

9. The liquid crystal display device of claim 1, further comprising a first transparent electrode on a surface of the first substrate.

10. The liquid crystal display device of claim 1, further comprising a light source module disposed at a side of another surface of the second substrate.

11. The liquid crystal display device of claim 10, further comprising a second polarizer disposed between the second substrate and the light source module.

12. The liquid crystal display device of claim 1, further comprising a first polarizer disposed at a side of another surface of the first substrate.

13. A method for constructing a liquid crystal display panel, comprising:
providing a first substrate;
providing a second substrate, wherein a surface of the second substrate comprises a second transparent electrode;
forming a reflective layer over at least a portion of the second transparent electrode
forming a cover layer over the reflective layer; and
forming a liquid crystal layer between the first substrate and the second substrate.

14. A liquid crystal display device, comprising:
a liquid crystal display panel as in claim 1; and
a drive control circuit controlling imaging of the liquid crystal display panel.

15. An electronic device, comprising:
a liquid crystal display device as in claim 13; and
an input device for providing an input data to the liquid crystal display device for rendering an image.

16. A substrate panel for a liquid crystal display panel, comprising:
a substrate, wherein a surface of the substrate comprises a transparent electrode;
a reflective layer, disposed over at least a portion of the transparent electrode; and
a cover layer, disposed over the reflective layer.
